(19) United States
(12) Patent Application Publication
(10) Pub. No.: US 2026/0092018 A1
(43) Pub. Date: Apr. 2, 2026

(54) METHOD FOR INTERNAL AND EXTERNAL COLLABORATIVE INTEGRATED PROTECTION OF CONCRETE

(71) Applicant: Harbin Institute of Technology, Harbin (CN)

(72) Inventors: Zongjing HE, Harbin (CN); Zhuoyan LI, Harbin (CN); Chen MU, Harbin (CN); Hongyan CHU, Harbin (CN); Huining XU, Harbin (CN); Yiqiu TAN, Harbin (CN)

(21) Appl. No.: 19/343,236

(22) Filed: Sep. 29, 2025

(30) Foreign Application Priority Data
Sep. 30, 2024 (CN) 202411382570.1

(51) Int. Cl. C04B 41/52; C04B 14/38; C04B 24/38; C04B 28/34; C04B 41/45; C04B 41/48; C04B 41/50; C04B 41/63; C04B 41/71; C04B 103/61; C09D 5/16; C09D 7/40; C09D 7/61; C09D 163/00; C09D 183/04; D06M 10/02; D06M 101/40

(52) U.S. Cl. CPC C04B 41/52; C04B 14/386; C04B 24/383; C04B 28/342; C04B 41/4539; C04B 41/4545; C04B 41/4853; C04B 41/488; C04B 41/5035; C04B 41/63; C04B 41/71; C09D 5/1675; C09D 5/1693; C09D 7/61; C09D 7/67; C09D 163/00; C09D 183/04; D06M 10/02; C04B 2103/61; D06M 2101/40

(57) ABSTRACT

A method for internal and external collaborative integrated protection of concrete is provided. The method has two aspects: first, combining reinforcement with cement and significantly enhancing compactness and strength of the concrete through a special surface treatment process; and second, successively constructing dual rough structures at microscopic and nanoscopic levels on the surface of the concrete through a super-hydrophobic anti-corrosive coating technology to form an efficient super-hydrophobic coating. The method effectively resists the erosion from external environments, solves problems such as carbonation of concrete, sulphate attack and corrosion of steel bar, and provides a high-performance and long-life concrete material solution for the field of civil engineering.

### TECHNICAL FIELD

The present invention relates to a method for protecting concrete.

### BACKGROUND

In the field of civil engineering, cement concrete, as a widely used building material, has durability and long-term stability directly related to the safety and lifespan of engineering structures. However, in practical application, cement concrete materials are often subject to erosion and damage from various complex environments, which leads to gradual deterioration of the performance and even structural failure. Such corrosion phenomenon is not limited to specific marine environments, but also widely exists in industrial pollution areas, areas around chemical plants, and areas with extreme climate changes.

The root cause of corrosion mainly lies in the interaction between external environmental factors and physical & chemical changes within the concrete. For example, harmful gases such as carbon dioxide and sulfides in the air as well as dissolved salts in water can penetrate into the interior of concrete and react with hydration products of the cement, leading to problems such as carbonation of concrete and sulphate attack. In addition, extreme temperature cycles, alternation of wetting and drying and other climatic conditions can also accelerate the expansion of micro-cracks in concrete, reducing compactness and strength. More seriously, when steel bars embedded in the concrete are eroded by a damp environment or harmful ions, an electrochemical corrosion reaction occurs, generating rust products with volume expansion, which further squeezes and damages the surrounding concrete cover, forming a vicious cycle. This process not only weakens the bearing capacity of the structure, but also may lead to sudden damage, posing a threat to the safety of people's lives and property.

Therefore, the development of cement concrete materials with high-efficient anti-corrosion performance and the corresponding protective technologies has become an important issue that urgently needs to be addressed in the current field of civil engineering. The anti-permeability, chemical resistance and durability of cement concrete can be effectively improved by enhancing the compactness of the cement concrete or applying a surface coating technology and other methods, thereby prolonging the service life of engineering structures and ensuring safe and stable operation.

### SUMMARY

The present invention aims to solve the technical problem that concrete materials are currently subject to erosion and damage from various complex environments, which leads to gradual deterioration of the performance and even structural failure, and provides a method for internal and external collaborative integrated protection of concrete.

The method for internal and external collaborative integrated protection of concrete of the present invention comprises the following steps:
I. Internal protection: providing a method for enhancing compactness of cement concrete by reinforcement, with a specific process as follows:
1. Carrying out surface treatment of reinforcement, wherein the reinforcement comprises one or a mixture of more of organic fibers, inorganic fibers, whiskers and carbon nanotubes;
2. Preparing cement gel, dissolving the reinforcement treated in step 1 into a solvent, adding the mixture to the cement gel for mixing, pouring the mixture into a mold for forming, and carrying out solidification, form removal and indoor curing to obtain a cement concrete specimen;
II. External protection: successively constructing dual rough structures at microscopic and nanoscopic levels on a surface of concrete through a super-hydrophobic anti-corrosive coating technology to form an efficient anti-corrosive coating, with a specific process as follows:

### 1. Construction of Microstructure

\textcircled{1} Dissolving resin and a curing agent with a solvent, heating in a water bath, and conducting magnetic stirring to obtain a mixed solution, wherein the mass ratio of the resin to the curing agent is (9-12):1;
\textcircled{2} Immersing a surface to be protected of the cement concrete specimen cured in step I into the mixed solution for 2-3 s, and then taking out the surface; and repeating this step twice, i.e., immersing three times in total, to obtain a bonding layer on the surface to be protected of the cement concrete specimen;
\textcircled{3} Uniformly dispersing particles on a surface of the bonding layer of the cement concrete specimen through a sieve to obtain a composite material with a microcosmic rough structure, and then carrying out solidification;

### 2. Construction of Nanostructure

\textcircled{1} Dissolving resin, a curing agent, a hydrophobic modifier and nano particles with a solvent, heating in a water bath, and conducting magnetic stirring to form a uniform super-hydrophobic suspension;

The mass ratio of the resin to the curing agent is (9-12):1; and the mass ratio of the curing agent to the hydrophobic modifier is 1:1;
\textcircled{2} Immersing a surface to be protected of the cement concrete solidified in step 1 into the super-hydrophobic suspension for 2-3 s, taking out the surface, and then carrying out solidification for 1-1.5 h;
\textcircled{3} Repeating the process of step \textcircled{2} once;
\textcircled{4} Immersing the surface to be protected of the cement concrete solidified in step \textcircled{3} into the super-hydrophobic suspension for 2-3 s, taking out the surface, and then carrying out solidification for 3-3.5 h to obtain a concrete structure with internal and external collaborative integrated protection.

The present invention provides a method for internal and external collaborative integrated protection of concrete, aiming to significantly enhance the durability and service life of concrete. The present invention is achieved through innovation in two aspects: first, combining reinforcement with cement and significantly enhancing compactness and strength of the concrete through a special surface treatment process; and second, successively constructing dual rough structures at microscopic and nanoscopic levels on the surface of the concrete through a super-hydrophobic anti-corrosive coating technology to form an efficient super-hydrophobic coating. The method of the present invention effectively resists the erosion from external environments, solves problems such as carbonation of concrete, sulphate attack and corrosion of steel bar, and provides a high-performance and long-life concrete material solution for the field of civil engineering. The concrete structure prepared by the present invention has significantly improved anti-corrosion performance compared with traditional cement-based materials, and exhibits enhanced self-cleaning, anti-freezing, anti-permeability, resistance to high and low temperature cycles, and resistance to ultraviolet aging.

### DESCRIPTION OF DRAWINGS

FIG. 1 is a comparison diagram of measurement results of a contact angle in test 5;

FIG. 2 is a data diagram of a coating contact angle under different numbers of frictions in test 6;

FIG. 3 is a photo of a coating surface of a sample 1 before a tape stripping test in contrast test 3 of test 7;

FIG. 4 is a photo of a coating surface of a sample 1 after tape stripping in contrast test 3 of test 7;

FIG. 5 is a photo of a coating surface of a sample 2 before a tape stripping test in contrast test 3 of test 7;

FIG. 6 is a photo of a coating surface of a sample 2 after tape stripping in contrast test 3 of test 7;

FIG. 7 is a photo of a coating surface of a sample 1 before a tape stripping test when the mass ratio of nano particles to absolute ethyl alcohol in test 1 of test 7 is 1:10;

FIG. 8 is a photo of a coating surface of a sample 1 after tape stripping when the mass ratio of nano particles to absolute ethyl alcohol in test 1 of test 7 is 1:10;

FIG. 9 is a photo of a coating surface of a sample 2 before a tape stripping test when the mass ratio of nano particles to absolute ethyl alcohol in test 1 of test 7 is 1:10;

FIG. 10 is a photo of a coating surface of a sample 2 after tape stripping when the mass ratio of nano particles to absolute ethyl alcohol in test 1 of test 7 is 1:10;

FIG. 11 is an image of scratches in contrast test 3 of test 8;

FIG. 12 is an image of scratches when the mass ratio of nano particles to absolute ethyl alcohol in test 1 of test 8 is 1:10;

FIG. 13 shows macroscopic morphology changes of cement-based test blocks treated in different ways before and after immersion in test 9.

### DETAILED DESCRIPTION

Specific embodiment 1: the present embodiment is a method for internal and external collaborative integrated protection of concrete, specifically comprising the following steps:
I. Internal protection: providing a method for enhancing compactness of cement concrete by reinforcement, with a specific process as follows:
1. Carrying out surface treatment of reinforcement, wherein the reinforcement comprises one or a mixture of more of organic fibers, inorganic fibers, whiskers and carbon nanotubes;
2. Preparing cement gel, dissolving the reinforcement treated in step 1 into a solvent, adding the mixture to the cement gel for mixing, pouring the mixture into a mold for forming, and carrying out solidification, form removal and indoor curing to obtain a cement concrete specimen;
II. External protection: successively constructing dual rough structures at microscopic and nanoscopic levels on a surface of concrete through a super-hydrophobic anti-corrosive coating technology to form an efficient anti-corrosive coating, with a specific process as follows:

### 1. Construction of Microstructure

\textcircled{1} Dissolving resin and a curing agent with a solvent, heating in a water bath, and conducting magnetic stirring to obtain a mixed solution, wherein the mass ratio of the resin to the curing agent is (9-12):1;
\textcircled{2} Immersing a surface to be protected of the cement concrete specimen cured in step I into the mixed solution for 2-3 s, and then taking out the surface; and repeating this step twice, i.e., immersing three times in total, to obtain a bonding layer on the surface to be protected of the cement concrete specimen;
\textcircled{3} Uniformly dispersing particles on a surface of the bonding layer of the cement concrete specimen through a sieve to obtain a composite material with a microcosmic rough structure, and then carrying out solidification;

### 2. Construction of Nanostructure

\textcircled{1} Dissolving resin, a curing agent, a hydrophobic modifier and nano particles with a solvent, heating in a water bath, and conducting magnetic stirring to form a uniform super-hydrophobic suspension;

The mass ratio of the resin to the curing agent is (9-12):1; and the mass ratio of the curing agent to the hydrophobic modifier is 1:1;

\textcircled{2} Immersing a surface to be protected of the cement concrete solidified in step 1 into the super-hydrophobic suspension for 2-3 s, taking out the surface, and then carrying out solidification for 1-1.5 h;
\textcircled{3} Repeating the process of step \textcircled{2} once;
\textcircled{4} Immersing the surface to be protected of the cement concrete solidified in step \textcircled{3} into the super-hydrophobic suspension for 2-3 s, taking out the surface, and then carrying out solidification for 3-3.5 h to obtain a concrete structure with internal and external collaborative integrated protection.
Specific embodiment 2: the present embodiment is different from specific embodiment 1 in that the organic fibers in step I comprise polyester fibers, polypropylene fibers, nylon fibers and natural fibers. Others are the same as those in specific embodiment 1.
Specific embodiment 3: the present embodiment is different from specific embodiment 1 or 2 in that the inorganic fibers in step I comprises glass fibers, carbon fibers, basalt fibers and metal fibers. Others are the same as those in specific embodiment 1 or 2.
Specific embodiment 4: the present embodiment is different from specific embodiment 3 in that when the reinforcement in step I is carbon fibers, a surface treatment method for the reinforcement is as follows:

### (1) Surface Desizing of Carbon Fibers

Placing a beaker with carbon fibers and absolute ethyl alcohol in an ultrasonic cleaner, and keeping an ultrasonic treatment mode on for 60 min to achieve effective desizing of surfaces of the carbon fibers;

Taking out the carbon fibers, and ultrasonically treating the carbon fibers in deionized water for 30 min to completely remove residual absolute ethyl alcohol from the surfaces of the carbon fibers;

Placing a container with the carbon fibers in an oven, and setting a temperature to 60-80° C. for drying until the carbon fibers reach a constant weight state, to obtain desized carbon fibers;

### (2) Heat Treatment of Carbon Fibers

Spreading the desized carbon fibers in the container, placing the container in a muffle furnace, and setting a temperature of the muffle furnace to 100-500° C. to carry out heat treatment of the carbon fibers for 10-30 min to complete the surface treatment of the carbon fibers. Others are the same as those in specific embodiment 3.
Specific embodiment 5: the present embodiment is different from specific embodiment 1 in that cement in the cement gel in step I comprises portland cement, sulphoaluminate cement, phosphate cement, high alumina cement or slag cement. Others are the same as those in specific embodiment 4.
Specific embodiment 6: the present embodiment is different from specific embodiment 5 in that the time of the indoor curing in step I is 28 days, and the temperature is 18-22° C. Others are the same as those in specific embodiment 5.
Specific embodiment 7: the present embodiment is different from specific embodiment 6 in that the curing agents in the construction of microstructure and nanostructure in step II are amine, anhydride, phenolic aldehyde, isocyanate or waterborne curing agents. Others are the same as those in specific embodiment 6.
Specific embodiment 8: the present embodiment is different from specific embodiment 7 in that the particles in step II are quartz sand particles, silicate minerals, silica powder or silica microbeads; and the solidification in 1 of step II is solidification at 45° C. for 5 h or solidification at room temperature. Others are the same as those in specific embodiment 7.
Specific embodiment 9: the present embodiment is different from specific embodiment 8 in that the hydrophobic modifier in step II is polydimethylsiloxane, fluorosilane hydrophobic modifier, organosilicone hydrophobic modifier or acrylate hydrophobic modifier. Others are the same as those in specific embodiment 8.
Specific embodiment 10: the present embodiment is different from specific embodiment 9 in that the nano particles in step II are nano SiO₂, nano TiO₂, nano Al₂O₃, carbon nanotubes, graphene nanosheets or nano clay. Others are the same as those in specific embodiment 9.

The present invention is verified by the following tests:
Test 1: this test is a method for internal and external collaborative integrated protection of concrete, specifically comprising the following steps:
I. Internal protection: providing a method for enhancing compactness of cement concrete by reinforcement, with a specific process as follows:
1. Surface treatment of carbon fibers:

### (1) Surface Desizing of Carbon Fibers

Laying a layer of carbon fibers at the bottom of a dried beaker to ensure uniform distribution of the fibers; adding absolute ethyl alcohol to the beaker to ensure that the liquid level completely covers the carbon fibers; placing a beaker with carbon fibers and absolute ethyl alcohol in an ultrasonic cleaner, and keeping an ultrasonic treatment mode on for 60 min to achieve effective desizing of surfaces of the carbon fibers; wherein the carbon fibers are 6 mm chopped carbon fibers;

Using tweezers to transfer the ultrasonically treated carbon fibers from the absolute ethyl alcohol to another beaker with deionized water to ensure that the carbon fibers are completely submerged, and conducting ultrasonic treatment for 30 min to thoroughly remove residual absolute ethyl alcohol from the surfaces of the carbon fibers;

Taking out the carbon fibers that have undergone secondary ultrasonic treatment from the deionized water, and gently spreading the carbon fibers in a clean stainless steel container to avoid overlapping; and placing the stainless steel container with the carbon fibers in an oven, and setting a temperature to 80° C. for drying until the carbon fibers reach a constant weight state, to obtain desized carbon fibers;

### (2) Heat Treatment of Carbon Fibers

Spreading the desized carbon fibers uniformly and smoothly in the stainless steel container, placing the stainless steel container in a muffle furnace, and setting a temperature of the muffle furnace to 300° C. to carry out heat treatment of the carbon fibers for 15 min to complete the surface treatment of the carbon fibers;
2. Adding carboxymethyl cellulose to water until completely dissolved, wherein the mass ratio of the carboxymethyl cellulose to the water is 1:400, thereby obtaining a solvent, and during this process, the carboxymethyl cellulose is used as a dispersing agent, aiming to promote uniform dispersion of the carbon fibers in the subsequent mixing steps;

Dissolving the carbon fibers heat-treated in step 1 into the solvent, wherein the mass ratio of the carbon fibers to the water is 0.01:1, thereby obtaining a carbon fiber dispersed solution, and using an electrical stirrer for stirring to ensure that the carbon fibers can be uniformly dispersed in the solution, wherein the rotational speed is set to 600 r/min;

Mixing cementing components of magnesium phosphate cement (the cementing components comprise dead burnt magnesium oxide, potassium dihydrogen phosphate and sodium decahydrate borate), wherein the mass ratio of the dead burnt magnesium oxide to the potassium dihydrogen phosphate to borax is 4:1:0.32. Placing the mixed cementing components in a stirring pot, starting stirring equipment for mechanical dry mixing at 62 r/min for 5 min. This step aims to pre-mix cementing materials to a nearly completely uniform state through a mechanical force. After the cementing materials are stirred uniformly, pouring the carbon fiber dispersed solution into the stirring pot at a constant speed, and continuing to stir for 90 s to form a uniform mixture, wherein the mass ratio of the sum of the dead burnt magnesium oxide, potassium dihydrogen phosphate and borax to the water in the mixture is 1:0.14. Pouring the mixture quickly and uniformly into a mold, and carrying out forming operation (vibration), and during this process, it is necessary to ensure that every corner of the mold is filled with the materials to avoid bubbles or voids. After the molding process is completed, standing for 15 min, and carrying out form removal operation once the materials are initially solidified. During form removal, be careful to avoid damage to a specimen. After form removal, placing the specimen indoors for natural curing for 28 days, and maintaining the curing temperature at 20° C., to obtain a cement concrete specimen (with a size of 160 mm×40 mm×20 mm);
II. External protection: successively constructing dual rough structures at microscopic and nanoscopic levels on a surface of concrete through a super-hydrophobic anti-corrosive coating technology to form an efficient anti-corrosive coating, with a specific process as follows:

### 1. Construction of Microstructure

\textcircled{1} Dissolving epoxy resin and a curing agent DETA with absolute ethyl alcohol, heating in a water bath, and conducting magnetic stirring for 5 min (500 r/min, 30° C.) to obtain a mixed solution, wherein the mass ratio of the epoxy resin to the curing agent is 10:1, and the mass ratio of the epoxy resin to the absolute ethyl alcohol is 1:2;
\textcircled{2} Immersing a surface to be protected (a 160 mm×40 mm non-exposed surface) of the cement concrete specimen cured in step I into the mixed solution for 2 s, and then taking out the surface; and repeating this step twice, i.e., immersing three times in total, to obtain a bonding layer on the surface to be protected of the cement concrete specimen;
\textcircled{3} Uniformly dispersing 40-60 mesh quartz sand particles on a surface of the bonding layer of the cement concrete specimen through a 60 mesh sieve to obtain a composite material with a microcosmic rough structure, and then carrying out solidification at 45° C. for 5 h;

### 2. Construction of Nanostructure

\textcircled{1} Dissolving epoxy resin, a curing agent DETA, polydimethylsiloxane (the mass ratio of part A to part B is 10:1) and nano particles with absolute ethyl alcohol, heating in a water bath, and conducting magnetic stirring for 30 min (300 r/min, 30° C.) to form a uniform super-hydrophobic suspension, wherein the nano particles are nano SiO₂;

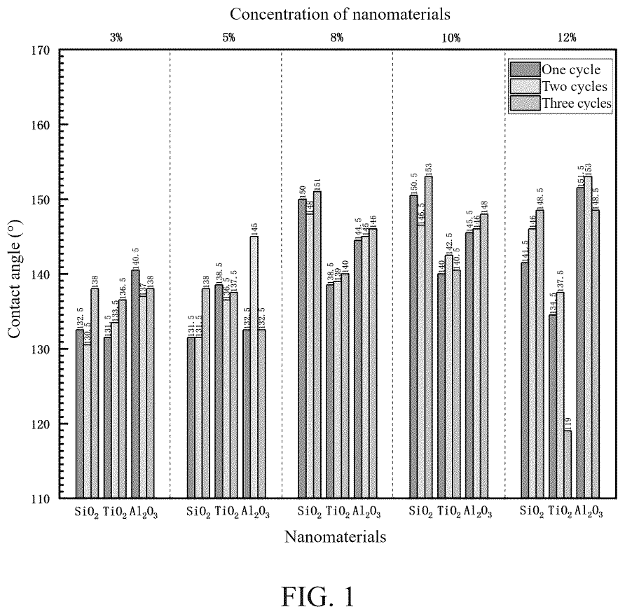

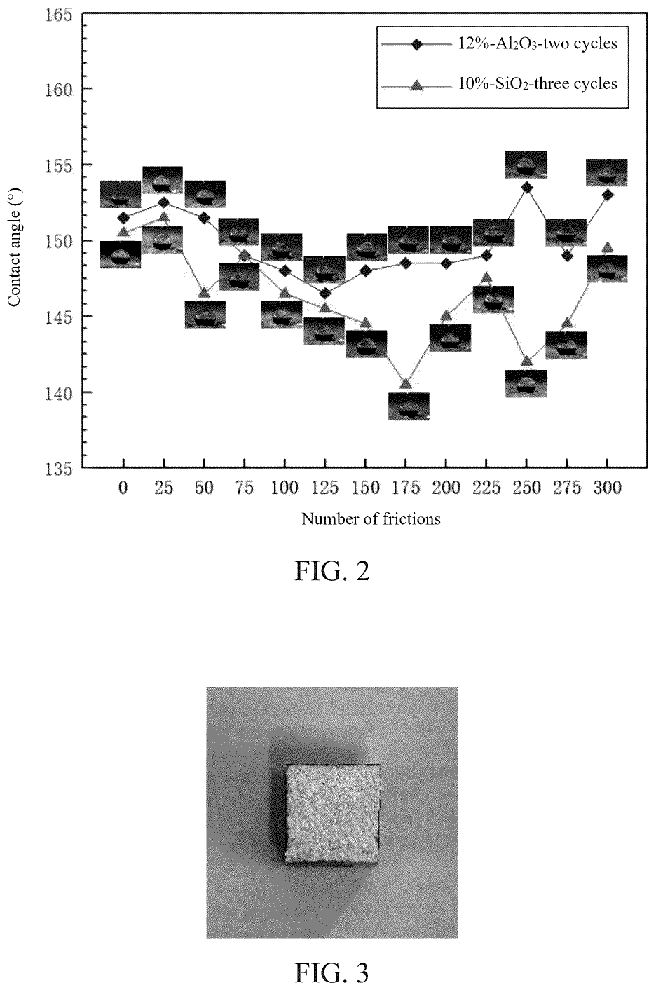

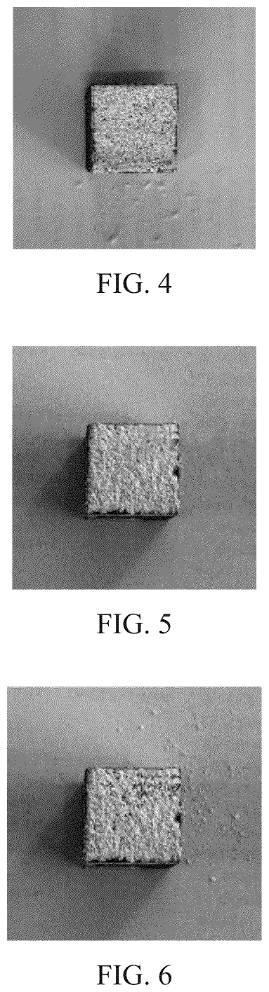

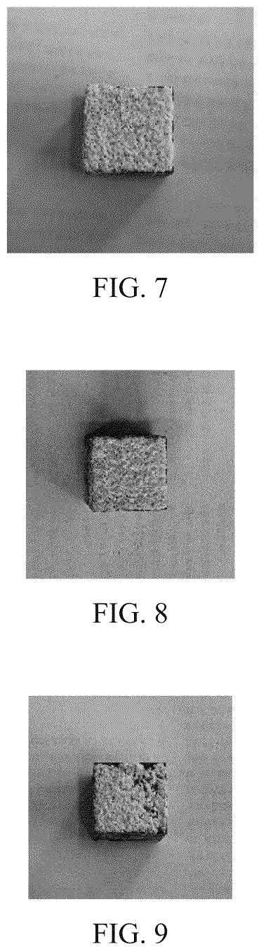

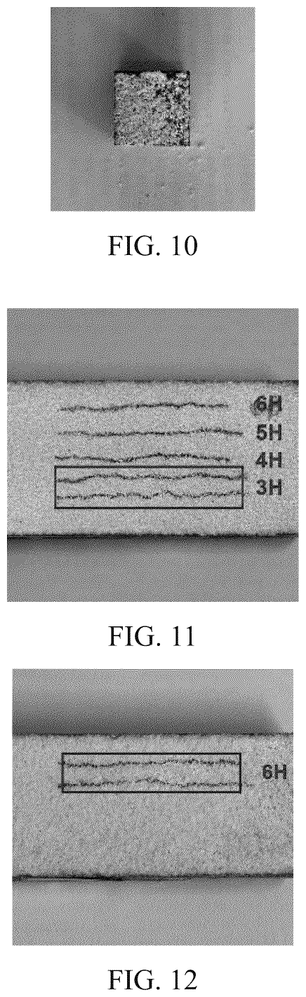

The mass ratio of the epoxy resin to the curing agent DETA is 10:1; the mass ratio of the epoxy resin to the absolute ethyl alcohol is 1:10; the mass ratio of the curing agent DETA to the polydimethylsiloxane is 1:1; and the mass ratios of the nano particles to the absolute ethyl alcohol are respectively (3, 5, 8, 10 and 12):100, and the five ratios are used for comparison;
\textcircled{2} Immersing a surface to be protected of the cement concrete solidified in step 1 into the super-hydrophobic suspension for 2 s, taking out the surface, and then carrying out solidification at 45° C. for 1 h;
\textcircled{3} Repeating the process of step \textcircled{2} once;
\textcircled{4} Immersing the surface to be protected of the cement concrete solidified in step \textcircled{3} into the super-hydrophobic suspension for 2 s, taking out the surface, and then carrying out solidification at 45° C. for 3 h to obtain a concrete structure with internal and external collaborative integrated protection.
Contrast test 1: the difference from test 1 is that the process of step (2) is repeated 0 time in step \textcircled{3} of construction of nanostructure, then solidification is carried out for 4 h in step \textcircled{4}, and others are the same as those in test 1, i.e., two cycles.
Contrast test 2: the difference from test 1 is that solidification is carried out for 5 h in step \textcircled{2} of construction of nanostructure, and step \textcircled{3} and step \textcircled{4} are canceled, i.e., one cycle. Others are the same as those in test 1.
Test 2: this test is different from test 1 in that the nano particles in step II are nano TiO₂. Others are the same as those in test 1.
Test 3: this test is different from test 1 in that the nano particles are nano Al₂O₃. Others are the same as those in test 1.
Contrast test 3: the difference from test 3 is that the process of step (2) is repeated 0 time in step \textcircled{3} of construction of nanostructure, then solidification is carried out for 4 h in step \textcircled{4}, and others are the same as those in test 1, i.e., two cycles.
Test 4: this test is different from test 1 in that the nano particles are carbon nanotubes. Others are the same as those in test 1.
Test 5: the contact angles of super-hydrophobic coatings prepared in test 1, test 2, test 3, test 4, contrast test 1 and contrast test 2 are measured by a wetting angle measuring instrument, the volume of water droplets used in the control test is 0.8-1 μL, and the average of data measured at two different positions on a super-hydrophobic surface is used as a contact angle measured value. The calculation of the contact angles is tested and analyzed by software that comes with a contact angle measuring instrument, and the results are shown in FIG. 1. The concentration of nanomaterials represents a mass fraction of nano particles in absolute ethyl alcohol. It is found by comparing the measured contact angle data of super-hydrophobic coating materials prepared from the same type of nanomaterials through the same number of treatments that for nano SiO₂, the contact angle increases with the increase of the concentration, and decreases when the concentration exceeds 10%, i.e., the optimum concentration of nano SiO₂ is 10%. Three groups of parameters meeting a super-hydrophobic condition (the contact angle is greater than) 150° are: SiO₂-8%-three cycles, SiO₂-10%-one cycle and SiO₂-10%-three cycles. Similarly, the optimum concentration of nano TiO₂ is also 10%. However, under the premise of keeping experimental conditions consistent, the contact angle data of TiO₂ is always observed to be lower than corresponding values of SiO₂ and Al₂O₃ nanomaterials. For nano Al₂O₃, the contact angle data always presents an increasing trend.
Test 6: 800# abrasive paper is prepared, and placed with a rough surface facing down on the coating surface of a specimen, a 200 g standard weight is placed on the abrasive paper, and the abrasive paper is manually pulled at a constant speed to move horizontally on the specimen. A complete friction on the coating surface by the position of the abrasive paper where the weight is located is recorded as one friction cycle. The variation of the contact angle of the super-hydrophobic coating after different friction cycles is measured, and the contact angle is used as an assessment index to assess the friction and wear resistance of the super-hydrophobic coating. The variation of the coating contact angle under different friction times is shown in FIG. 2. ▴ represents that the mass ratio of the nano particles to the absolute ethyl alcohol in test 1 is 1:10; and ♦ represents contrast test 3. It can be seen from the figure that under the same test conditions, a coating with a parameter of 12%-Al₂O₃-two cycles has a contact angle always maintained at a higher level than a coating with a parameter of 10%-SiO₂-three cycles, which indicates that the coating with a parameter of 12%-Al₂O₃-two cycles has better hydrophobic performance. Moreover, the contact angle of the coating with 12%-Al₂O₃-two cycles has a relatively small fluctuation range, reaching a maximum of 153.5° and a minimum of 146.5°, with only a difference of 7°, whereas the contact angle of the coating with 10%-SiO₂-three cycles has a relatively large variation range, decreasing from the maximum of 151.5° to the minimum of 140.5°, with a difference of 11°. This comparison indicates that the coating with 12%-Al₂O₃-two cycles exhibits better stability during the process of friction and wear.
Test 7: to enhance the reliability of the data and reduce test errors, two specimens are selected as parallel samples for each coating ratio for testing. After the coating is fully solidified, 64 square grids with a size of 2 mm×2 mm are evenly scratched on the surface of the specimen with a cross-cut tester, then debris are removed from scratches with a brush, and finally, 3M tapes are evenly stuck onto the small square grids. After 2 min, the tapes are quickly removed from the coating surface, and the adhesion of the super-hydrophobic coating is assessed based on the integrity of paint films in the grids. The test results are shown in Table 1 and FIG. 3 to FIG. 10. FIG. 3 is a photo of a coating surface of a sample 1 before a tape stripping test in contrast test 3; FIG. 4 is a photo of a coating surface of a sample 1 after tape stripping in contrast test 3; FIG. 5 is a photo of a coating surface of a sample 2 before a tape stripping test in contrast test 3; FIG. 6 is a photo of a coating surface of a sample 2 after tape stripping in contrast test 3; FIG. 7 is a photo of a coating surface of a sample 1 before a tape stripping test when the mass ratio of nano particles to absolute ethyl alcohol in test 1 is 1:10; FIG. 8 is a photo of a coating surface of a sample 1 after tape stripping when the mass ratio of nano particles to absolute ethyl alcohol in test 1 is 1:10; FIG. 9 is a photo of a coating surface of a sample 2 before a tape stripping test when the mass ratio of nano particles to absolute ethyl alcohol in test 1 is 1:10; and FIG. 10 is a photo of a coating surface of a sample 2 after tape stripping when the mass ratio of nano particles to absolute ethyl alcohol in test 1 is 1:10. It can be seen that both coatings have strong adhesion to substrates. The reason is that the epoxy resin adhesive layer at the bottom of the coating is thermosetting resin, a highly cross-linked three-dimensional network structure of which endows the epoxy resin with excellent bonding performance and presents good mechanical robustness against tape stripping.

TABLE 1
Results of Tape Stripping Test

| | Group | | | |
|---|---|---|---|---|
| | | | The mass ratio of nano particles | |
| | Contrast test 3 | | to absolute ethyl alcohol in test 1 | |
| | (12%-Al₂O₃-two cycles) | | is 1:10 (10%-SiO₂-three cycles) | |
| Sample | 1 | 2 | 1 | 2 |
| Results of | 4B | 4B | 5B | 4B |
| adhesion test | | | | |

Test 8: coatings in test 1 and contrast test 3 are scratched in sequence with pencils from a hardest pencil until the selected pencil does not scratch the coating, which is recorded as the hardness of paint film, as shown in Table 2, FIG. 11 and FIG. 12. FIG. 11 is an image of scratches in contrast test 3, and FIG. 12 is an image of scratches when the mass ratio of nano particles to absolute ethyl alcohol in test 1 is 1:10. It can be known from the figures that the coating with a parameter of 10%-SiO₂-three cycles has better hardness than the coating with a parameter of 12%-Al₂O₃-two cycles, and the hardness level is increased to 6H, which may be due to high hardness of SiO₂ as well as uniform distribution and good combination of SiO₂ in the coating, contributing to significant increase of the hardness of the coating in combination with the preparation process of three cycles.

TABLE 2
Comparison of hardness of coating
samples with different parameters

| | Pencil |
|---|---|
| Sample | hardness level |
| Contrast test 3 (12%-Al₂O₃-two cycles) | 3H |
| The mass ratio of nano particles to absolute ethyl | 6H |
| alcohol in test 1 is 1:10 (10%-SiO₂-three cycles) | |

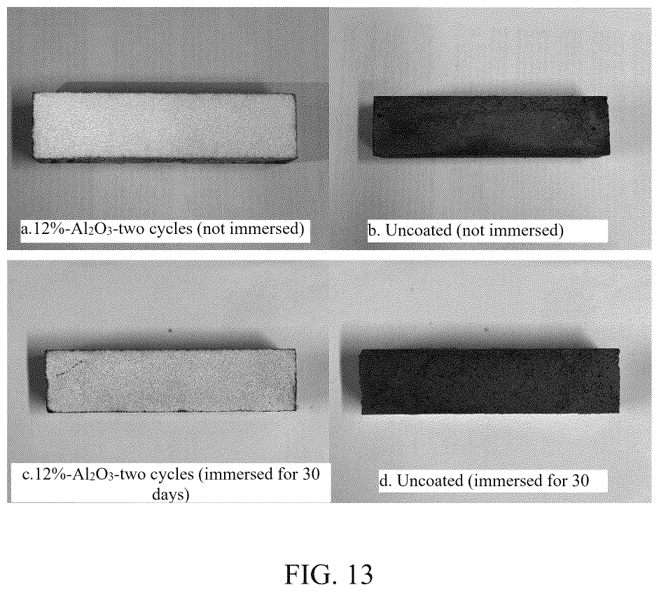

Test 9: cement test blocks (products of internal protection in step I of test 1) without super-hydrophobic coatings in contrast test 3 are placed in a NaCl solution with a mass concentration of 3.5%. Table 3 shows the variation of the contact angle after the coating is immersed for 30 days. FIG. 13 shows macroscopic morphology changes of cement-based test blocks treated in different ways before and after immersion, and it is found by observation that the surface morphology has no obvious change.

TABLE 3
Variation of coating contact angle with immersion time (unit: °)

| Immersion time | Contrast test 3 |
|---|---|
| (days) | (12%-Al₂O₃-two cycles |
| 0 | 152 |
| 30 | 149.5 |

Test 10: freeze-thaw cycle test: a sample is placed in a freeze-thaw cycle test chamber, and the variation of the coating contact angle and the variation of adhesion between the coating and the substrate are tested to assess the freeze-thaw resistance of the coating, as shown in Table 4 and Table 5.

TABLE 4
Variation of coating contact angle with
number of freeze-thaw cycles (unit: °)

| | | The mass ratio of nano |
|---|---|---|
| Number of | | particles to absolute ethyl |
| freeze-thaw | Contrast test 3 | alcohol in test 1 is 1:10 |
| cycles | (12%-Al₂O₃-two cycles) | (10%-SiO₂-three cycles) |
| 0 | 152.0 | 151.5 |
| 25 | 145.0 | 143.5 |
| 50 | 140.0 | 136.0 |

TABLE 5
Variation of adhesion between coating and
substrate with number of freeze-thaw cycles

| | | The mass ratio of nano |
|---|---|---|
| Number of | | particles to absolute |
| freeze-thaw | Contrast test 3 | ethyl alcohol in test 1 is |
| cycles | (12%-Al₂O₃-two cycles) | 1:10 (10%-SiO₂-three cycles) |
| 0 | 4B | 5B |
| 25 | 4B | 5B |
| 50 | 1B | 5B |

Based on the data comparative analysis in the table, the variation of the surface contact angle of the coating treated with 12%-Al₂O₃-two cycles in contrast test 3 after 50 freeze-thaw cycle tests is less significant than the coating treated with 10%-SiO₂-three cycles in test 1. However, it should be noted that the coating treated with 12%-Al₂O₃-two cycles shows more significant attenuation in adhesion, indicating that the coating treated with 12%-Al₂O₃-two cycles has certain advantages over the stability of the contact angle in terms of freeze-thaw resistance, but is more affected in the bonding strength between the coating and the substrate.

1. A method for internal and external collaborative integrated protection of concrete, comprising the following steps:
SI. an internal protection process that comprises providing a method for enhancing compactness of cement concrete by reinforcement, which comprises:
SI-1: carrying out surface treatment of reinforcement, wherein the reinforcement is carbon fibers, a surface treatment method for the reinforcement is as follows:
SI-11: surface desizing of carbon fibers
placing a beaker with carbon fibers and absolute ethyl alcohol in an ultrasonic cleaner, and keeping an ultrasonic treatment mode on for 60 min to achieve effective desizing of surfaces of the carbon fibers;
taking out the carbon fibers, and ultrasonically treating the carbon fibers in deionized water for 30 min to completely remove residual absolute ethyl alcohol from the surfaces of the carbon fibers; placing a container with the carbon fibers in an oven, and setting a temperature to 60-80° C. for drying until the carbon fibers reach a constant weight state, to obtain desized carbon fibers;
SI-12: heat treatment of carbon fibers
spreading the desized carbon fibers in the container, placing the container in a muffle furnace, and setting a temperature of the muffle furnace to 100-500° C. to carry out heat treatment of the carbon fibers for 10-30 min to complete the surface treatment of the carbon fibers;
SI-2: preparing cement gel, dissolving the reinforcement treated in step SI-1 into a solvent, adding the mixture to the cement gel for mixing, pouring the mixture into a mold for forming, and carrying out solidification, form removal and indoor curing to obtain a cement concrete specimen;
Adding carboxymethyl cellulose to water until completely dissolved, wherein the mass ratio of the carboxymethyl cellulose to the water is 1:400, thereby obtaining a solvent.
SII: an external protection process that comprises successively constructing dual rough structures at microscopic and nanoscopic levels on a surface of concrete through a super-hydrophobic anti-corrosive coating technology to form an efficient anti-corrosive coating, with a specific process as follows:
SII-1: construction of microstructure
SII-11: dissolving resin in anhydrous ethanol and a curing agent with a solvent, heating in a water bath, and conducting magnetic stirring to obtain a mixed solution, wherein the mass ratio of the resin to the curing agent is (9-12):1;
SII-12: immersing a surface to be protected of the cement concrete specimen cured in step SI into the mixed solution for 2-3 s, and then taking out the surface; and repeating this step twice, i.e., immersing three times in total, to obtain a bonding layer on the surface to be protected of the cement concrete specimen;
SII-13: uniformly dispersing particles on a surface of the bonding layer of the cement concrete specimen through a sieve to obtain a composite material with a microcosmic rough structure, and then carrying out solidification;
SII-2: construction of nanostructure
SII-21: dissolving resin in anhydrous ethanol, a curing agent, a hydrophobic modifier and nano particles with a solvent, heating in a water bath, and conducting magnetic stirring to form a uniform super-hydrophobic suspension;
the mass ratio of the resin to the curing agent is (9-12):1; and the mass ratio of the curing agent to the hydrophobic modifier is 1:1;
SII-22: immersing a surface to be protected of the cement concrete specimen solidified in step SII into the super-hydrophobic suspension for 2-3 s, taking out the surface, and then carrying out solidification for 1-1.5 h;
SII-23: repeating the process of step SII-22 once;
SII-24: immersing the surface to be protected of the cement concrete specimen solidified in step SII-23 into the super-hydrophobic suspension for 2-3 s, taking out the surface, and then carrying out solidification for 3-3.5 h to obtain a concrete structure with internal and external collaborative integrated protection.

2. The method for internal and external collaborative integrated protection of concrete according to claim 1, wherein cement in the cement gel in step SI comprises portland cement, sulphoaluminate cement, phosphate cement, high alumina cement or slag cement.

3. The method for internal and external collaborative integrated protection of concrete according to claim 1, wherein the time of the indoor curing in step SI is 28 days, and the temperature is 18-22° C.

4. The method for internal and external collaborative integrated protection of concrete according to claim 1, wherein the curing agents in the construction of microstructure and nanostructure in step SII are amine, anhydride, phenolic aldehyde, isocyanate or waterborne curing agents.

5. The method for internal and external collaborative integrated protection of concrete according to claim 1, wherein the particles in step II are quartz sand particles, silicate minerals, silica powder or silica microbeads; and the solidification in 1 of step SII is solidification at 45° C. for 5 h or solidification at room temperature.

6. The method for internal and external collaborative integrated protection of concrete according to claim 1, wherein the hydrophobic modifier in step SII is polydimethylsiloxane, fluorosilane hydrophobic modifier, organosilicone hydrophobic modifier or acrylate hydrophobic modifier.

7. The method for internal and external collaborative integrated protection of concrete according to claim 1, wherein the nano particles in step SII are nano SiO₂, nano TiO₂, nano Al₂O₃, carbon nanotubes, graphene nanosheets or nano clay.
